(19) United States
(12) Patent Application Publication
(10) Pub. No.: US 2007/0271397 A1
(43) Pub. Date: Nov. 22, 2007

(54) Molding-system controller-interface apparatus

(75) Inventors: Peter John Dungar, Maumee, OH (US); Scott Allen Phillips, Brighton, MI (US); Teodor Andrei Tarita-Nistor, Woodbridge (CA); Alex Knaus, Richmond Hill (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, US

(73) Assignee: Husky Injection Molding Systems Ltd.

(21) Appl. No.: 11/435,590

(22) Filed: May 17, 2006

(51) Int. Cl. G06F 15/16

(52) U.S. Cl. 709/249

(57) ABSTRACT

Disclosed are: (i) a molding-system controller-interface apparatus, (ii) a molding-system controller having a molding-system controller-interface apparatus, (iii) a molding system having a molding-system controller including a molding-system controller-interface apparatus, (iv) an auxiliary-system controller having a molding-system interface apparatus, (v) an auxiliary-system including an auxiliary controller having a molding-system interface apparatus, (vi) a method of a molding-system interface apparatus, amongst other things.

### TECHNICAL FIELD

The present invention generally relates to, but is not limited to, molding systems, and more specifically the present invention relates to, but is not limited to, (i) a molding-system controller-interface apparatus, (ii) a molding-system controller having a molding-system controller-interface apparatus, (iii) a molding system having a molding-system controller including a molding-system controller-interface apparatus, (iv) an auxiliary-system controller having a molding-system interface apparatus, (v) an auxiliary-system including an auxiliary controller having a molding-system interface apparatus, (vi) a method of a molding-system controller-interface apparatus, amongst other things.

### BACKGROUND

U.S. Pat. No. 5,062,052 (Inventor: Sparer et al; Published: Oct. 29, 1991) discloses a controller for a plastics molding-machine that separates control and analysis functions, and processes both analogue and digital signals.

U.S. Pat. No. 5,062,053 (Inventor: Shirai et al; Published Oct. 29, 1991) discloses an automatic-operation system for an injection-molding machine that controls the machine through start-up, purging, molding and restart after abnormal conditions have been detected.

U.S. Pat. No. 5,176,858 (Inventor: Tsukabe et al; Published: Jan. 5, 1993) discloses control of a molding machine for flash free and void free moldings by sensing presence of flash and voids, inputting valves to control unit which outputs corrective temperature and pressure data.

U.S. Pat. No. 5,229,952 (Inventor: Galloway et al; Published: Jul. 20, 1993) discloses a servo-controlled injection-molding machine that has a module for producing set-point signals for comparison with measured parameter valves.

U.S. Pat. No. 6,275,741 (Inventor: Choi; Published: Aug. 14, 2001) discloses a control apparatus for an injection-molding system that includes a human-machine interface (HMI), and a general purpose computer coupled to both the HMI and injection-molding devices.

United States Patent Application Number 2003/0182010A1 (Inventor: Erhardt; Published: Sep. 25, 2003) discloses a plastic-processing machine-regulation system that has a general-purpose computer for controlling operation of a motion controller and a human-machine interface.

U.S. Pat. No. 6,658,318 (Inventor: Kimura; Published: Dec. 2, 2003) discloses a synchronous-operating method that involves starting predetermined operation of each injection-molding machine simultaneously based on time of starting of slowest-operating injection-molding machine.

U.S. Pat. No. 6,684,264 (Inventor: Choi; Published: Jan. 27, 2004) discloses a man-machine interface for an injection-molding machine that is networked with a multitasking computer which controls operating functions using updated software.

U.S. Pat. No. 6,969,245 (Inventor: Mörwald et al; Published: Nov. 29, 2005) discloses an injection-molding machine for manufacturing plastic articles. The machine includes electronic stored-program controls for the injection-molding machine and a handling device, which are realized on one and same common digital computer.

### SUMMARY

According to a first aspect of the present invention, there is provided a molding-system controller-interface apparatus, including at least three different types of communication layers communicatively couplable to a molding-system controller and to an auxiliary controller.

According to a second aspect of the present invention, there is provided a molding-system controller, having a molding-system controller-interface apparatus including at least three different types of communication layers communicatively couplable to the molding-system controller and to an auxiliary controller.

According to a third aspect of the present invention, there is provided a molding system, including a molding-system controller having a molding-system controller-interface apparatus including at least three different types of communication layers communicatively couplable to the molding-system controller and to an auxiliary controller.

According to a fourth aspect of the present invention, there is provided an auxiliary system controller having a molding-system controller-interface apparatus, including at least three different types of communication layers communicatively couplable to a molding-system controller and to the auxiliary-system controller.

According to a fifth aspect of the present invention, there is provided an auxiliary system including an auxiliary controller having a molding-system controller-interface apparatus including at least three different types of communication layers communicatively couplable to a molding-system controller and to the auxiliary system controller.

According to a sixth aspect of the present invention, there is provided a method, including using at least three different types of communication layers to communicatively couplable to a molding-system controller and to an auxiliary-system controller.

A technical effect of the aspects of the present invention is, amongst other things, there may be improved integration of operations between an auxiliary system and a molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is schematic representation of a molding-system controller-interface apparatus according to a first exemplary embodiment.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

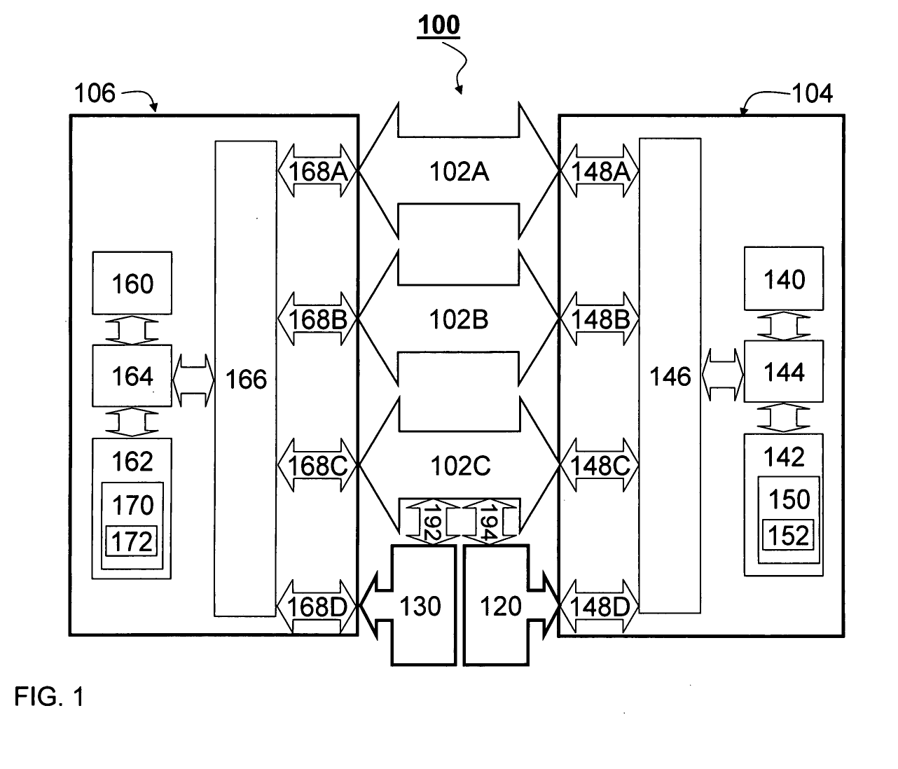

FIG. 1 is schematic representation of a molding-system controller-interface apparatus 100 (hereafter referred to as “the MSCIA 100”) according to a first exemplary embodiment. Variations and alternatives of the MSCIA 100 will be described below. The MSCIA 100 includes at least three different types of communication layers 102A, 102B, 102C that are communicatively couplable to a molding-system controller 104 and to an auxiliary-system controller 106. A communication layer is sometimes called a “link”. A communication layer allows communication between the molding-system controller 104 and the auxiliary-system controller 106. The MSCIA 100 is not limited to using only three different types of communication layers, and that in fact a multitude of different types of communication layers may be used. However, for sake of simplifying the description of the first exemplary embodiment, three different types of communication layers are described. Preferably, the at least three different types of communication layers 102A, 102B, 102C directly connect or couple the controllers 104, 106 together.

The at least three different types of communication layers 102A, 102B, 102C use a communication medium to communicate and/or transmit signals (data signals and/or control signals) between the controllers 104, 106. According to one variant, the at least three different types of communication layers 102A, 102B, 102C may operate over a single communications medium; preferably, each of the at least three different types of communication layers 102A, 102B, 102C operate over a respective (dedicated) communications medium. For example, the communications medium may be (but is not limited to): (i) electrical-wire based communications medium for communicating signals via one or more electrical wires (such as: RS-232 for connecting serial devices, RS-485 for multipoint communications, RS-422 and/or RS-423 for connecting serial devices, RJ45 cable used to communicate signals from computers to local-area networks, CAT 5 cable which is an unshielded twisted-pair cable type designed for high signal integrity, etc), (ii) infra-red based communications medium (such as: IrDA, etc) for transmitting signals via infrared-light waves, (iii) radio-frequency (RF) based communication medium in which any frequency within the electromagnetic spectrum associated with radio wave propagation is used to communicate signals.

Preferably, the at least three different types of communication layers 102A, 102B, 102C include a first communication layer 102A (hereafter referred to as “the first layer 102A”) that is configured to communicate real-time signals (and/or data) between the molding-system controller 104 and the auxiliary-system controller 106. The first layer 102A uses a real-time communication protocol. A real-time communication layer is a layer that responds in a (timely) predictable way to unpredictable external stimuli. A real-time communication layer may support the communication of signals with time constraints on delivery of the signals. A real-time communication layer guarantees a response to an external event (such as request to communicate a signal) within a given time. For example, the first layer 102A uses a real-time communication protocol for real-time data processed by real-time applications (and/or variables), real-time physical devices and I/O, etc. Preferably, the first layer 102A includes an industrial field bus. Industrial field buses are sub-divided into categories depending on the capabilities they offer, such as (but not limited to): (i) control-bus types (real-time Ethernet, ControlNet), (ii) field buses (Foundation Fieldbus, Profibus), (iii) device buses (DeviceNet, Profibus DP, SDS, Interbus-S), and/or (iv) sensor buses (CAN, ASI, Seriplex, LonWorks).

Preferably, the at least three different types of communication layers 102A, 102B, 102C include a second communication layer 102B (hereafter referred to as “the second layer 102B”) that is configured to communicate non-real-time data between the molding-system controller 104 and the auxiliary-system controller 106. The second layer 102B uses a non-real-time communication protocol. A non-real-time communication layer does not necessarily have to guarantee a response to an external event (such as request to communicate a signal) within a given time. The second layer 102B permits a high volume of data (signals) to be transferred between the controllers 104, 106 and the data is used for processing non-time dependent applications (and/or variables), physical devices and I/O, etc. Preferably, the second layer 102B includes a non-real-time connection, such as (but not limited to) the non-real-time Ethernet connection. Other examples of the second layer 102B are (but not limited to): (i) Ethernet using standard TCP/IP (Transmission Control Protocol/Internet Protocol), (ii) HTTP (HyperText Transfer Protocol), (iii) FTP (File Transfer Protocol), (iv) RS-232 for connecting serial devices, and/or (v) RS-485 for multipoint communications, etc.

Preferably, the at least three different types of communication layers 102A, 102B, 102C include a third communication layer 102C (hereafter referred to as “the third layer 102C”) that is configured to communicate at least one safety-circuit signal (or more that one safety-circuit signal), which may or may not include hardwired connections. Preferably, the third layer 102C includes an electrical-hardware communication connection for safety interlocks and discrete I/Os (inputs and/or outputs). Examples of the safety-circuit signal includes (but not limited to): (i) an emergency-stop request, (ii) a safety-gates open indication, (iii) discrete inputs, (iv) discrete outputs, (v) electrical-hardware interlocks, etc. Preferably, the third layer 102C includes the Euromap 12 interface and/or the Euromap 67 interface (both of which are generally known as the Euromap interface). Euromap is a committee of national associations of machinery manufacturers for plastics and rubber industries in Europe (www.euromap.org). According to a variation, the third layer 102C is configured to communicate safety-interlock signal that is a member of the SPI robotics interface. SPI is an acronym for the Society of the Plastics Industry (www.plasticsindustry.org). Preferably, the third layer 103C is also connected to the molding system 120 and to the auxiliary system 130 (via connections 192, 194), so that the safety signals may be passed directly between the systems 120, 130 (so that the systems 120 may react quickly to the safety signals issued by the system 130 and visa versa) and so that the controller 104, 106 may monitor the status of the safety signals.

Another technical effect of the first exemplary embodiment is that the MSCIA 100 may use the at least three different types of communications layers 102A, 102B, 102C to permit the controllers 104, 106 to pass signals between themselves so as to minimize negative impacts to communication capabilities of signals communicated via any one of the layers 102A, 102B 102C. For example: the MSCIA 100 passes data for Ethernet applications that are non-essential to a runtime of the controllers 104, 106 while passing real-time data for processing time-critical applications (and/or variables) while providing essential safety and other interlock signals.

Preferably, the molding-system controller 104 is operatively couplable to a molding system 120. The auxiliary-system controller 106 is operatively couplable to an auxiliary system 130. Preferably, the auxiliary system 130 includes a robot that is used to handle parts molded by the molding system 120. Other types of auxiliary systems are: conveyor systems, cooling systems, hot-runner controllers, part-inspection systems, etc.

Preferably, the controller 104 includes an internal bus 144 that is used to operatively couple a processor unit 140 to other devices, such as an article of manufacture 142 and input/output-interface bus 146 (hereafter referred to as “the bus 146”). The bus 146 uses interface connections 148A, 148B, 148C, 148D to connect the bus 146 to the three communications layers 102A, 120B, 102C, respectively. The third layer 102C may be directly connected to the molding system 120 and to the auxiliary system 130, and the controller 104 and/or the controller 106 may be connected to the third layer 102C so as to monitor the status of the signals being communicated by the third layer 102C. The article of manufacture 142 includes a controller usable medium 150 that embodies one or more instructions 152. The instructions 152 are used to direct the controller 104 to communicate with the controller 106 via the at least three communications layers 102A, 102B, 102C. The controller usable medium 150 may be a hard disk or a CD (compact disk), a floppy disk, and/or a signal communicated to the controller 104 via a network (not depicted) coupled to the controller 104. Optionally connected to the controller 104 is a user-interface screen, keyboard, mouse, etc (not depicted).

Preferably, the controller 106 includes an internal bus 164 that is used to operatively couple a processor unit 160 to other devices, such as an article of manufacture 162 and input/output-interface bus 166 (hereafter referred to as “the bus 166”). The bus 166 uses interface connections 168A, 168B, 168C, 168D to connect the bus 166 to the three communications layers 102A, 120B, 102C, respectively. The article of manufacture 162 includes a controller usable medium 170 that embodies one or more instructions 172. The instructions 172 are used to direct the controller 106 to communicate with the controller 104 via the at least three communications layers 102A, 102B, 102C. The controller usable medium 170 may be a hard disk or a CD (compact disk), a floppy disk and/or a signal communicated to the controller 106 via a network (not depicted) coupled to the controller 106. Optionally connected to the controller 106 is a user-interface screen, keyboard, mouse, etc (not depicted).

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A molding-system controller-interface apparatus, comprising:
at least three different types of communication layers communicatively couplable to a molding-system controller and to an auxiliary-system controller.

2. The molding-system controller-interface apparatus of claim 1, wherein the at least three different types of communication layers include a first communication layer configured to communicate real-time data.

3. The molding-system controller-interface apparatus of claim 1, wherein the at least three different types of communication layers include a first communication layer configured to communicate real-time data, the first communication layer includes an industrial field bus.

4. The molding-system controller-interface apparatus of claim 1, wherein the at least three different types of communication layers include a first communication layer configured to communicate real-time data, the first communication layer includes a real-time Ethernet connection.

5. The molding-system controller-interface apparatus of claim 1, wherein the at least three different types of communication layers include a second communication layer configured to communicate non-real-time data.

6. The molding-system controller-interface apparatus of claim 1, wherein the at least three different types of communication layers include a second communication layer configured to communicate non-real-time data, the second communication layer includes a non-real-time Ethernet connection.

7. The molding-system controller-interface apparatus of claim 1, wherein the at least three different types of communication layers include a third communication layer configured to communicate a safety-circuit signal.

8. The molding-system controller-interface apparatus of claim 1, wherein the at least three different types of communication layers include a third communication layer configured to communicate safety-interlock data, the safety-interlock data being a member of the Euromap interface.

9. The molding-system controller-interface apparatus of claim 1, wherein the at least three different types of communication layers include a third communication layer configured to communicate safety-interlock data, the safety-interlock data being a member of the SPI robotics interface.

10. The molding-system controller-interface apparatus of claim 1, wherein the molding-system controller is operatively couplable to a molding system, and the auxiliary-system controller is operatively couplable to an auxiliary system.

11. The molding-system controller-interface apparatus of claim 1, wherein the molding-system controller is operatively couplable to a molding system, and the auxiliary-system controller is operatively couplable to an auxiliary system, the auxiliary system includes a robot.

12. A molding-system controller, comprising:
a molding-system controller-interface apparatus including at least three different types of communication layers communicatively couplable to the molding-system controller and to an auxiliary-system controller.

13. The molding-system controller of claim 12, wherein the at least three different types of communication layers include a first communication layer configured to communicate real-time data.

14. The molding-system controller of claim 12, wherein the at least three different types of communication layers include a first communication layer configured to communicate real-time data, the first communication layer includes an industrial field bus.

15. The molding-system controller of claim 12, wherein the at least three different types of communication layers include a first communication layer configured to communicate real-time data, the first communication layer includes a real-time Ethernet connection.

16. The molding-system controller of claim 12, wherein the at least three different types of communication layers include a second communication layer configured to communicate non-real-time data.

17. The molding-system controller of claim 12, wherein the at least three different types of communication layers include a second communication layer configured to communicate non-real-time data, the second communication layer includes a non-real-time Ethernet connection.

18. The molding-system controller of claim 12, wherein the at least three different types of communication layers include a third communication layer configured to communicate a safety-circuit signal.

19. The molding-system controller of claim 12, wherein the at least three different types of communication layers include a third communication layer configured to communicate safety-interlock data, the safety-interlock data being a member of the Euromap interface.

20. The molding-system controller of claim 12, wherein the at least three different types of communication layers include a third communication layer configured to communicate safety-interlock data, the safety-interlock data being a member of the SPI robotics interface.

21. The molding-system controller of claim 12, wherein the molding-system controller is operatively couplable to a molding system, and the auxiliary-system controller is operatively couplable to an auxiliary system.

22. The molding-system controller of claim 12, wherein the molding-system controller is operatively couplable to a molding system, and the auxiliary-system controller is operatively couplable to an auxiliary system, the auxiliary system includes a robot.

23. A molding system, comprising:
a molding-system controller having a molding-system controller-interface apparatus including at least three different types of communication layers communicatively couplable to the molding-system controller and to an auxiliary-system controller.

24. The molding system of claim 23, wherein the at least three different types of communication layers include a first communication layer configured to communicate real-time data.

25. The molding system of claim 23, wherein the at least three different types of communication layers include a first communication layer configured to communicate real-time data, the first communication layer includes an industrial field bus.

26. The molding system of claim 23, wherein the at least three different types of communication layers include a first communication layer configured to communicate real-time data, the first communication layer includes a real-time Ethernet connection.

27. The molding system of claim 23, wherein the at least three different types of communication layers include a second communication layer configured to communicate non-real-time data.

28. The molding system of claim 23, wherein the at least three different types of communication layers include a second communication layer configured to communicate non-real-time data, the second communication layer includes a non-real-time Ethernet connection.

29. The molding system of claim 23, wherein the at least three different types of communication layers include a third communication layer configured to communicate a safety-circuit signal.

30. The molding system of claim 23, wherein the at least three different types of communication layers include a third communication layer configured to communicate safety-interlock data, the safety-interlock data being a member of the Euromap interface.

31. The molding system of claim 23, wherein the at least three different types of communication layers include a third communication layer configured to communicate safety-interlock data, the safety-interlock data being a member of the SPI robotics interface.

32. The molding system of claim 23, wherein the molding-system controller is operatively couplable to the molding system, and the auxiliary-system controller is operatively couplable to an auxiliary system.

33. The molding system of claim 23, wherein the molding-system controller is operatively couplable to the molding system, and the auxiliary-system controller is operatively couplable to an auxiliary system, the auxiliary system includes a robot.

34. An auxiliary-system controller, comprising:
a molding-system controller-interface apparatus including at least three different types of communication layers communicatively couplable to a molding-system controller and to the auxiliary-system controller.

35. The auxiliary-system controller of claim 34, wherein the at least three different types of communication layers include a first communication layer configured to communicate real-time data.

36. The auxiliary-system controller of claim 34, wherein the at least three different types of communication layers include a first communication layer configured to communicate real-time data, the first communication layer includes an industrial field bus.

37. The auxiliary-system controller of claim 34, wherein the at least three different types of communication layers include a first communication layer configured to communicate real-time data, the first communication layer includes a real-time Ethernet connection.

38. The auxiliary-system controller of claim 34, wherein the at least three different types of communication layers include a second communication layer configured to communicate non-real-time data.

39. The auxiliary-system controller of claim 34, wherein the at least three different types of communication layers include a second communication layer configured to communicate non-real-time data, the second communication layer includes a non-real-time Ethernet connection.

40. The auxiliary-system controller of claim 34, wherein the at least three different types of communication layers include a third communication layer configured to communicate a safety-circuit signal.

41. The auxiliary-system controller of claim 34, wherein the at least three different types of communication layers include a third communication layer configured to communicate safety-interlock data, the safety-interlock data being a member of the Euromap interface.

42. The auxiliary-system controller of claim 34, wherein the at least three different types of communication layers include a third communication layer configured to communicate safety-interlock data, the safety-interlock data being a member of the SPI robotics interface.

43. The auxiliary-system controller of claim 34, wherein the molding-system controller is operatively couplable to a molding system, and the auxiliary-system controller is operatively couplable to an auxiliary system.

44. The auxiliary-system controller of claim 34, wherein the molding-system controller is operatively couplable to a molding system, and the auxiliary-system controller is operatively couplable to an auxiliary system, the auxiliary system includes a robot.

45. An auxiliary system, comprising:
an auxiliary controller having a molding-system controller-interface apparatus including at least three different types of communication layers communicatively couplable to a molding-system controller and to an auxiliary-system controller.

46. The auxiliary system of claim 45, wherein the at least three different types of communication layers include a first communication layer configured to communicate real-time data.

47. The auxiliary system of claim 45, wherein the at least three different types of communication layers include a first communication layer configured to communicate real-time data, the first communication layer includes an industrial field bus.

48. The auxiliary system of claim 45, wherein the at least three different types of communication layers include a first communication layer configured to communicate real-time data, the first communication layer includes a real-time Ethernet connection.

49. The auxiliary system of claim 45, wherein the at least three different types of communication layers include a second communication layer configured to communicate non-real-time data.

50. The auxiliary system of claim 45, wherein the at least three different types of communication layers include a second communication layer configured to communicate non-real-time data, the second communication layer includes a non-real-time Ethernet connection.

51. The auxiliary system of claim 45, wherein the at least three different types of communication layers include a third communication layer configured to communicate a safety-circuit signal.

52. The auxiliary system of claim 45, wherein the at least three different types of communication layers include a third communication layer configured to communicate safety-interlock data, the safety-interlock data being a member of the Euromap interface.

53. The auxiliary system of claim 45, wherein the at least three different types of communication layers include a third communication layer configured to communicate safety-interlock data, the safety-interlock data being a member of the SPI robotics interface.

54. The auxiliary system of claim 45, wherein the molding-system controller is operatively couplable to a molding system, and the auxiliary-system controller is operatively couplable to the auxiliary system.

55. The auxiliary system of claim 45, wherein the molding-system controller is operatively couplable to a molding system, and the auxiliary-system controller is operatively couplable to the auxiliary system, the auxiliary system includes a robot.

56. A method, comprising:
using at least three different types of communication layers to communicatively couplable to a molding-system controller and to an auxiliary-system controller.

57. The method of claim 56, further comprising:
including a first communication layer configured to communicate real-time data.

58. The method of claim 56, further comprising:
including a first communication layer configured to communicate real-time data, the first communication layer includes an industrial field bus.

59. The method of claim 56, further comprising:
including a first communication layer configured to communicate real-time data, the first communication layer includes a real-time Ethernet connection.

60. The method of claim 56, further comprising:
including a second communication layer configured to communicate non-real-time data.

61. The method of claim 56, further comprising:
including a second communication layer configured to communicate non-real-time data, the second communication layer includes a non-real-time Ethernet connection.

62. The method of claim 56, further comprising:
including a third communication layer configured to communicate a safety-circuit signal.

63. The method of claim 56, further comprising:
including a third communication layer configured to communicate safety-interlock data, the safety-interlock data being a member of the Euromap interface.

64. The method of claim 56, further comprising:
including a third communication layer configured to communicate safety-interlock data, the safety-interlock data being a member of the SPI robotics interface.

65. The method of claim 56, further comprising:
operatively coupling the molding-system controller to a molding system, and
operatively coupling the auxiliary-system controller to an auxiliary system.

66. The method of claim 56, further comprising:
operatively coupling the molding-system controller to a molding system, and
operatively coupling the auxiliary-system controller to an auxiliary system, the auxiliary system includes a robot.
